(19) United States
(12) Patent Application Publication
(10) Pub. No.: US 2003/0160759 A1
(43) Pub. Date: Aug. 28, 2003

(54) Method and system for displaying search results

(75) Inventors: Jacquelyn Annette Martino, Cold Spring, NY (US); Lira Nikolovska, Eindhoven (NL); Jeanne de Bont, Maar Heele (NL); John Zimmerman, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/086,008

(22) Filed: Feb. 28, 2002

(51) Int. Cl. G09G 5/08

(52) U.S. Cl. 345/157

(57) ABSTRACT

A display mechanism for showing search results, which is well-suited to displaying programming events on an electronic program guide, selectively aggregates items in result lists according to features having identical or similar values. Each aggregated item is represented by a respective symbol. A user interface may be provided to permit the selective expansion of the symbols. The resulting list has much less repetition than a list according to the prior art in which each search result is shown explicitly.

### FIELD OF THE INVENTION

The invention relates to the display of search results in various different kinds of search systems and data display systems such as electronic media guides, and to those in which result lists are concentrated by aggregating search results with common attributes.

### BACKGROUND

Search engines and other interfaces for choosing media, such as broadcast media or recording titles, are used in various contexts to filter from a large body of data objects that are assumed to be relevant to a user's interests. The vast amount of information available in CD-ROMS, the Internet, television programming guides, the proposed national information infrastructure, etc. spur the dream of easy access to many large information media sources. Such increased access to information is likely to be useful, but the prospect of such large amounts of information presents new challenges for the design of user interfaces for the search engines and browsing tools used to review and select information. For example, Internet users often struggle to find information sources. Straight text lists that are the usual mechanism provided by search engines, EPGs, text search tools such as Folio®, etc. are tedious to work with, because of the rather monotonous look, and because of the great redundancy that can exist in such lists. The list structure is an intuitively simply way for search results to be displayed but, they can be repetitious when many items have the same characteristics. Such repetition can be particularly annoying to a user when the user is not interested in the items with the same characteristic.

### SUMMARY OF THE INVENTION

A search engine display process, which may be run on a general-purpose computer or electronic program guide (EPG), for example, consolidates search results around features of the result set. Generally, the list format of a search result represents all distinct search results out as separate list items. According to an embodiment of the invention, list items with a similar feature are represented as a single list item. For example, items having the same title may be so-combined. According to a feature of the embodiment, the aggregated items may be selectively expanded in response to an indication with a pointer.

According to various embodiments, features about which list items may be collapsed can be any feature including meta-data that may or may not be displayed to the user. The search results can be derived from implicit or explicit profiles or from a search query or from other sources such as standardized queries based on time of day, season, class of operator, etc. The source data can be from a database resident on an all purpose computer, a network or Internet, a remote server with EPG data or other broadcast data, a local copy of such data, etc.

Various mechanisms for expanding the data hidden by consolidation include tracking with a mouse pointer, tab-switching with a remote key or keyboard. When a particular list item is indicated, the list item may be expanded to expose the individual items according other features that characterize it. For example, television program may be expanded by episode or date and time. The expansion may be done in list form or some other way such as by breaking out the items in columns or on a display object that gives the appearance of rotating in a third dimension. The features used for sorting, aggregating, and expanding may be selected and the display automatically updated in accord with the current selections.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 shows a diagram indicating a process for implementing the invention according to an embodiment thereof.

FIG. 2 shows an example of a hardware environment for implementing an embodiment of the invention.

FIGS. 3 and 4 illustrate a traditional list format for displaying search results according to the prior art.

FIG. 5 illustrates aggregation of list data according to an embodiment of the invention.

FIG. 6 illustrates an example of a display showing aggregated list data and a mode of expansion of that list data according to an embodiment of the invention.

FIG. 7 illustrates an example of a display showing aggregated list data and another mode of expansion of that list data according to an embodiment of the invention.

FIG. 8 illustrates an example of a display showing aggregated list data and yet another mode of expansion of that list data according to an embodiment of the invention.

FIGS. 9-11 illustrate another example of a display that is aggregated and which can be expanded while retaining features of a list and using a combined expansion control and indicator of hierarchical structure in various stages of expansion.

### DETAILED DESCRIPTION OF THE PREFERRED EMBODIMENTS

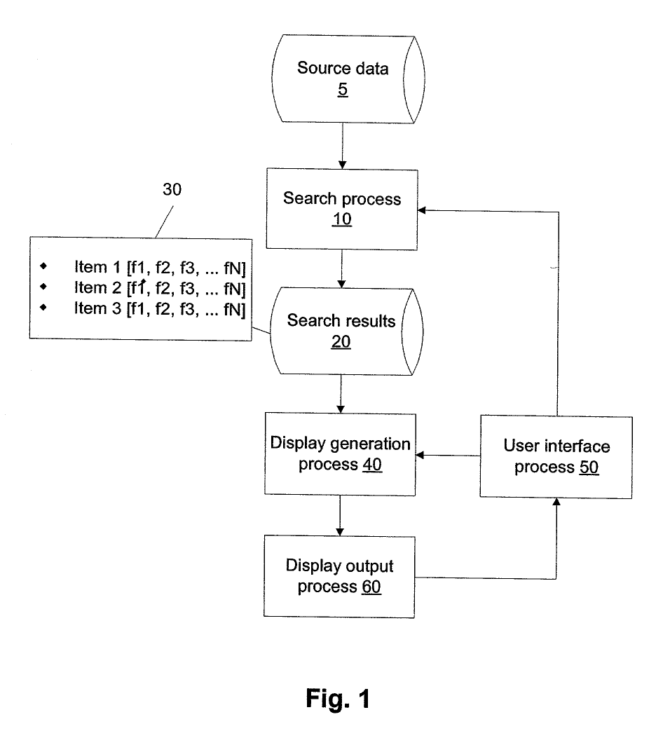

Referring to FIG. 1, a process for searching and displaying search results is shown for illustrating one possible functional mechanism for implementing the invention. Source data 5, which may reside on a remote server or peer, a local data store, or other data store or source is filtered by a search process 10 controlled by a user interface process 50 in a manner in accord with any current or future mechanism for searching and filtering data. The search process produces a filtered set of search results 20. A display generation process 40 then accesses the search results 20 and formats it for output by a display output process 60. The display generation process 40 is also under control of the user interface process 50.

The search results 20 may take the form of a list of data or pointers to data in the source data 5. Each item may correspond to a selection, for example a document or a television program that would be used by the user. Each item (indicated as Items 1-N in a callout 30) has various features (indicated as f1-fN in the callout 30) that may take on any of various possible values. Note that the user interface process may include soft controls such as display graphic controls like buttons, radio buttons, etc. in combination with or as alternatives to hardware controls such as a television-type remote control. The process may display criteria and feature value sets for use in searching and may display the search results generated by the display output process 60. The configuration illustrated by FIG. 1 is only one of many possible as will be appreciated by persons of skill in the relevant fields of art in light of the current specification.

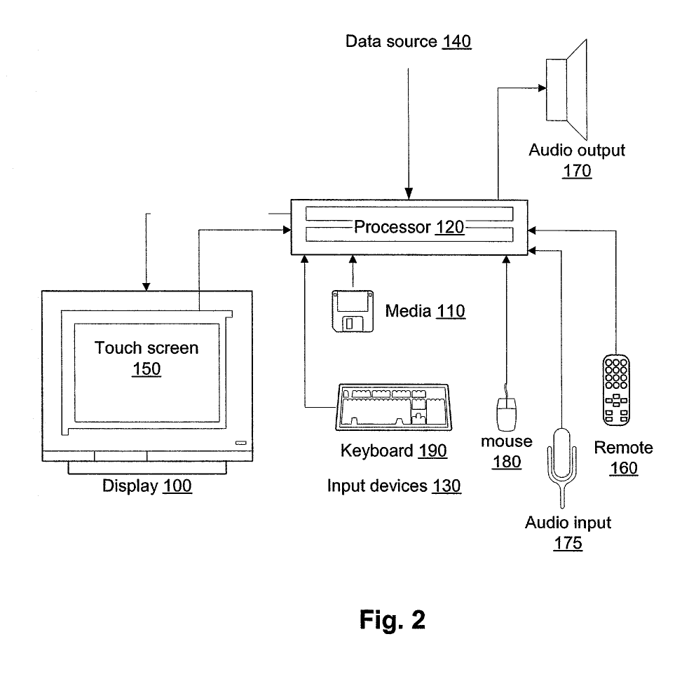

Referring now also to FIG. 2, a hardware environment that may be employed to generate the processes shown in FIG. 1 includes a processor 120 which may be an embedded system, a control processor including internal memory and storage, a general purpose computer, etc. The processor 120 receives data from a data source 140, which may provide the source data 5 illustrated in FIG. 1, from a remote server or local data store or any other source (not shown). Various input devices 130 such as a keyboard, touch screen 150, mouse 180, audio input (e.g., microphone) 175, handheld remote control 160, etc. may be used to provide input to the user interface process 50 of FIG. 1. Search results and controls may be displayed on a monitor display 100 which may be a television LCD screen or other display. Results or controls may be provided in part or in toto by an audio interface whose output is a speaker 170 according to various techniques for such interfaces, such as audio prompting and speech input. User profiles or predefined queries stored on removable media 110 may be entered into the processor 120 according to any suitable means or media type.

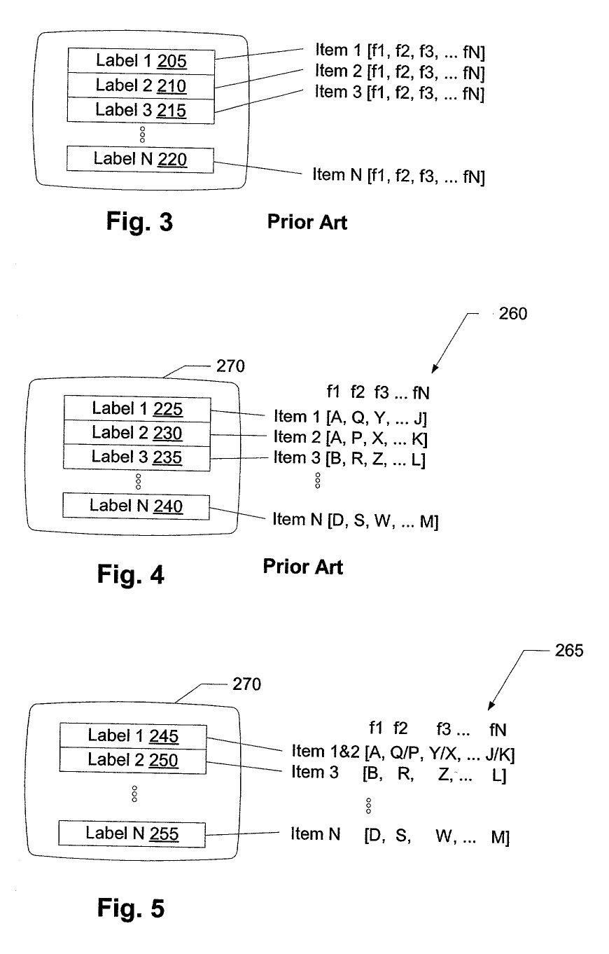

Referring now also to FIG. 3, in prior art systems, search results are displayed in a display area 270 by simply listing labels 205-210, each corresponding to a search result. As discussed above and illustrated here, each search result (items 1-N) is characterized by a set of features indicated as f1-fn. Referring now to FIG. 4, each feature has a respective value in a given search result. In the illustration of FIG. 4, as in that of FIG. 3, a set of labels 225-240 are shown in the display area 270, each corresponding to a respective search result (Item 1-Item N). In this example, Item 1, feature fl has value A, Item 1, feature f2 has value Q, and Item 2, feature fl as value A. The other items and features have the values indicated. Referring now also to FIG. 5, Items 1 and 2 are consolidated into a single item with a single label 245 because they have the same value for feature 1 as indicated at 265. For example, if feature fl represented the title of a program, only one label would be listed for all programs with that title.

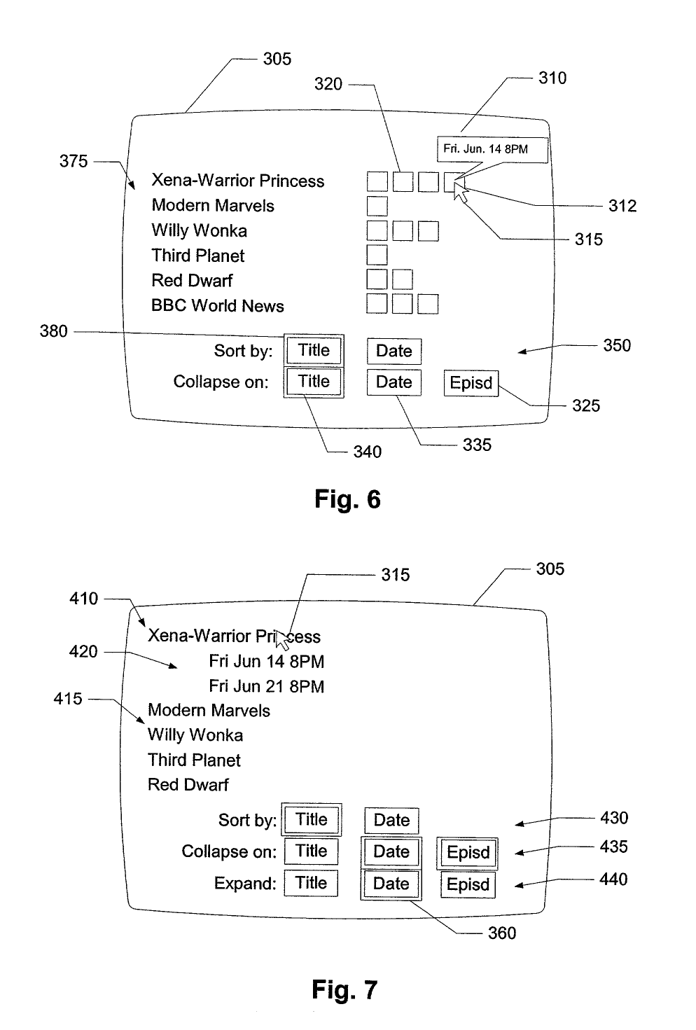

Referring to FIG. 6, in an example of the listing method shown in FIG. 5, a display area shows a set of labels 375 for television programs. Each of the labels indicates the title of the program. Each title may have multiple instances in the search result and so each of the labels 375 may indicate more than one program with a unique date and time, episode of a series, etc. In the present embodiment, each unique item in the search results is indicated by a tile or icon 320 on the display. Each icon may represent one or more search result items consolidated around a different feature, for example, there may be multiple episodes broadcast simultaneously, but these are represented by one icon indicating the time of the broadcast. Information about each entry corresponding to an icon 320 may be shown via a callout 310 or similar device such as a text box located somewhere on the screen. In the illustration, the callout is activated by user selection, such as by pointing to it with a pointer 315. In the example, each icon represents a date and time. But each may be aggregated about date and time and therefore each may encompass multiple channels and/or episodes.

In instances where each icon 320 represents search result items, such as separate broadcast events, the callout 310 or text box (not shown) may list all of these results, each with its respective date/time, channel, episode, etc. To permit the user to control the sorting and consolidation of search results, various controls such as indicated at 325, 335, 340, and 350 may be provided either in the display area 305 as illustrated or permanently or software enabled on another device such as a remote 160 or keyboard 190 or other device with a display such as a programmable remote (not shown). For example, controls may allow the sorting of the list of labels 375 on title or date or for the list items to be aggregated on title, date, or episode as indicated by the user. Current selections may be indicated by some sort of highlighting as indicated at 30 and 380.

Referring now to FIG. 7, in another example of a display format, instead of exploding the hidden features using a callout 310 as in FIG. 6, the search results and the attending hidden features are shown in an indented list 420. The indented list may be invoked selectively by the user using, for example, a pointer 315 as in the example of FIG. 6. As in the embodiment of FIG. 6, various controls may be provided to permit the user to indicate how to sort 430, aggregate 435, and expand 440 the search results. As each control is modified, the display may be instantly updated to reflect the currently-chosen selections.

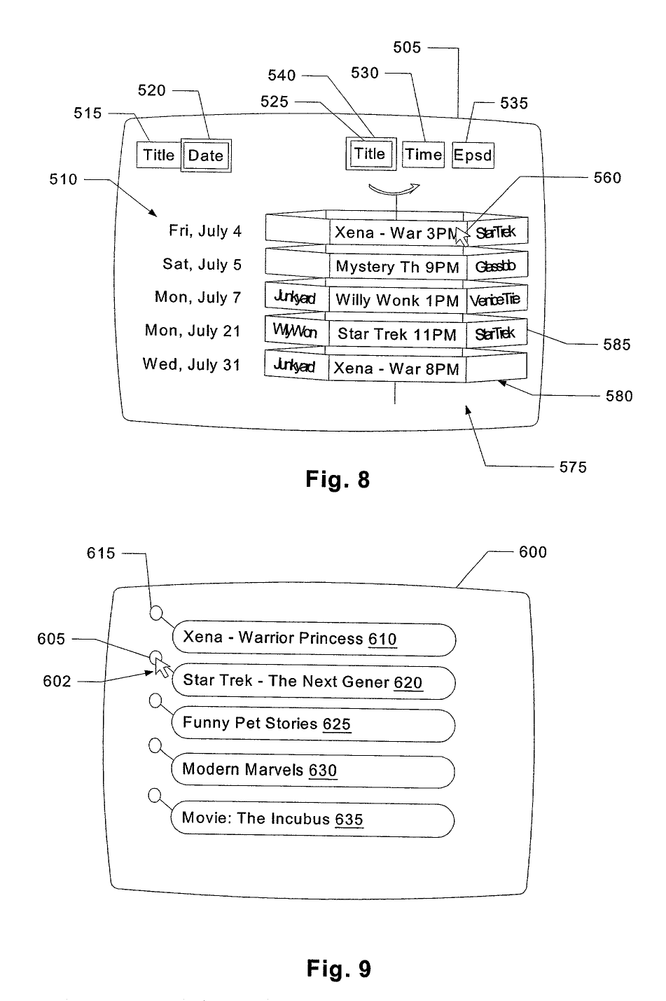

Referring now to FIG. 8, in another example, search results are show in a list 510 according to date. Time, title, and other attributes are aggregated. The display 505 shows, however, a control/display object 575 that gives the appearance of a set of rings each ring 580 being made up of tiles 585, each tile 585 corresponding to an individual entry in the search result. As in the prior embodiments, the search results may be selectively aggregated at multiple levels using controls 515, 535, 535, etc. Here, each tile 585 shows a title and time as indicated by the current selection highlights, for example as indicated at 540 for title. To view the various entries, each ring 580 may be rotated by selecting with the pointer 560 so that a current selection faces forward. The order of tiles may be any desired and may be controlled by the using another sort control (not shown).

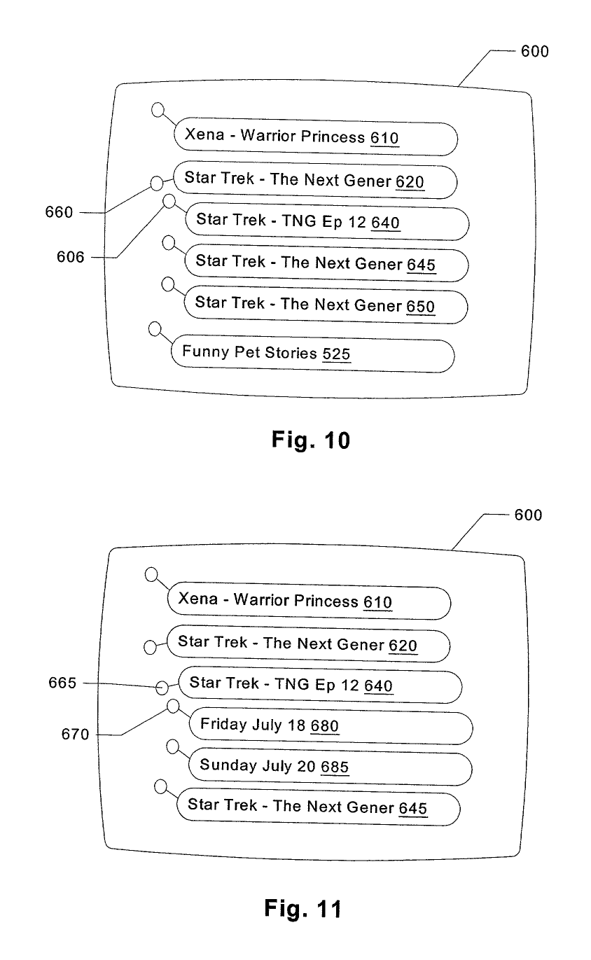

Referring now to FIG. 9, another embodiment a display area 600 shows list items 610, 620, 625, 630, and 635. Each list item, for example list item 620, has a control 605, which also serves as an indicator of whether the list item 610 has been expanded or not. In the list comprising list items 610, 620, 625, 630, and 635, each item, as in the other examples, may represent more than one search result. Thus, the results displayed as list items 610, 620, 625, 630, and 635 may regarded as the search results represented as a top level of hierarchy. To explode the first level for a given list item, for example list item 610, the control 605 may be moved down using, for example, a pointer 602. Referring now also to FIG. 10, moving the control 605 down causes the control to lock in a lowered position while expanding the hierarchical level represented by list item 620 to be exploded revealing a next level including list items 640, 645, and 650. The latter indicate particular episodes of the dominant list item 660 which is indicated with its control in a down-position at 660. The controls of the subtending list items 640, 645, and 650 have their controls, for example the control 605 of list item 640 in an up-position.

Referring to FIG. 11, each item among list items 640, 645, and 650 can be further expanded to reveal a lower level of hierarchy, in this case consisting of broadcast times indicated by list items 680 and 685. If this were the final level of hierarchy, the controls, for example that 670 of list item 680, at this level could be omitted. But this level might be further exploded to reveal multiple broadcast channels or other information.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

For example, although the controls, e.g., 670 and 775 are shown as handles, they could be replaced by tiles or other symbols that are actuated and the hierarchy level indicated by some other display parameter such as an icon or the color of the list item.

We claim:

1. A device for displaying search results, comprising:
at least one user interface and supporting processor connected thereto, said user interface having at least one control and at least one output;
said processor being configured to accept search results;
said user interface being adapted to apply control signals responsive to user input indicating a first feature or each of said search results;
said processor being configured to generate display data including multiple symbols corresponding to respective ones of said search results such that ones of said search results having a same value of said first feature are indicated by a single symbol;
said processor being adapted to output said symbols for display by said user interface in the format of a list extending along a first axis of a display area.

2. A device as in claim 1, wherein:
at least some of said search results having a second feature;
said display data including symbols corresponding to multiple instances of said ones of said search results having a same value, each of said ones being selectively displayable by said user interface developed along a second axis of said display area.

3. A device as in claim 2, wherein said ones are displayed by said user interface along said second axis of said display area by indicating said symbol corresponding to said ones.

4. A device as in claim 2, wherein said first axis defines a column.

5. A device as in claim 1, wherein said ones are displayed by said user interface along said second axis of said display area on a display control.

6. A device as in claim 5, wherein said display control permits selective expansion of details of said ones.

7. A device as in claim 6, wherein said ones may be selectively aggregated about chosen third features.

8. A device as in claim 1, wherein said search results are broadcast events.

9. A device as in claim 1, wherein said first feature includes at least one of title, time, date, channel, and episode of a program event.

10. A device for displaying search results, comprising:
at least one user interface and supporting processor connected thereto, said user interface having at least one control and at least one output;
said processor being configured to accept search results, said search results including broadcast events;
said user interface being adapted to apply control signals responsive to user input indicating a first feature or each of said search results;
said first feature including at least one of title, time, date, channel, and episode of a program event;
said processor being configured to generate display data including multiple symbols corresponding to respective ones of said search results such that ones of said search results having a same value of said first feature are indicated by a single symbol.

11. A device as in claim 10, wherein:
at least some of said search results having a second feature;
said display data including symbols corresponding to multiple instances of said ones of said search results having a same value, each of said ones being selectively displayable by said user interface developed along a second axis of said display area.

12. A device as in claim 11, wherein said ones are displayed by said user interface along said second axis of said display area by indicating said symbol corresponding to said ones.

13. A device as in claim 11, wherein said first axis is vertical and said second is horizontal.

14. A device as in claim 10, wherein said ones are displayed by said user interface along said second axis of said display area on a display control.

15. A method of displaying search results, comprising:
receiving user data indicating a first feature about which to consolidate search results;
identifying search results having save values of said first feature;
generating a display indicating each of said search results having said same values with a single symbol;
expanding said each of said search results such that additional information about said each is displayed in response to said single symbol being indicated by a user.

16. A method as in claim 15, wherein said search results include broadcast events.

17. A method as in claim 16, wherein said first feature includes at least one of title, time, date, channel, and episode of a program event.
